(19) United States
(12) Patent Application Publication
(10) Pub. No.: US 2026/0119278 A1
(43) Pub. Date: Apr. 30, 2026

(54) Work Distribution in a Data Center based on Compute Node Efficiency

(71) Applicant: Advanced Micro Devices, Inc., Santa Clara, CA (US)

(72) Inventors: Srilatha Manne, Seattle, WA (US); Rajagopalan Desikan, Austin, TX (US); Heather Lynn Hanson, Austin, TX (US); Shidhartha Das, Great Cambourne (GB); David Sinclair, Middleton, WI (US)

(73) Assignee: Advanced Micro Devices, Inc., Santa Clara, CA (US)

(21) Appl. No.: 18/934,204

(22) Filed: Oct. 31, 2024

(51) Int. Cl. G06F 9/50; G06F 11/34

(52) U.S. Cl. CPC G06F 9/5094; G06F 9/5011; G06F 11/3476

(57) ABSTRACT

In accordance with the described techniques, a system includes a plurality of compute nodes including a management node and a plurality of execution nodes. A processor of the management node is configured to read efficiency metrics associated with respective execution nodes of the plurality of execution nodes from one or more registers of the management node. Based on the efficiency metrics, the processor distributes software processes among the plurality of execution nodes for execution.

### BACKGROUND

Data centers are specialized facilities designed to house a large number of computer systems and associated components, such as telecommunications and storage systems. These facilities are equipped with extensive infrastructure to support high-performance computing, including redundant power supplies, advanced cooling systems, and robust security measures. Data centers are critical for large-scale deployments, which involve the implementation and management of vast numbers of servers, virtual machines, and network resources to handle significant computational workloads and data storage needs. Large-scale deployments are characterized by their scalability, allowing for the addition of resources as demand grows, and their ability to provide high availability and fault tolerance through redundancy and load balancing. These deployments support a wide range of applications, from cloud computing services and big data analytics to enterprise-level information technology infrastructure and high-performance computing environments. By leveraging the capabilities of data centers, organizations can ensure efficient, reliable, and scalable operations that meet the demands of modern digital ecosystems

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement work distribution in a data center based on compute node efficiency.

FIG. 3 depicts an example of an efficiency metric of an execution node having multiple fields indicating different categories of computational performance and power consumption characteristics.

FIG. 4 depicts a procedure in an example implementation of work distribution in a data center based on compute node efficiency as implemented by a management node.

FIG. 5 depicts a procedure in an example implementation of work distribution in a data center based on compute node efficiency as implemented by an execution node.

### DETAILED DESCRIPTION

### Overview

In accordance with the described techniques, a data center includes a plurality of compute nodes, and the compute nodes include a management node and a plurality of execution nodes. In various examples, the compute nodes are server computers each including one or more systems-on-chips (SoCs). Due to normal variations in physical characteristics of SoCs resulting from the SoC fabrication process, different SoCs exhibit different computational performance and power consumption characteristics. Indeed, some SoCs exhibit increased dynamic power efficiency but also increased static power consumption, while other SoCs exhibit decreased static power consumption but also decreased dynamic power efficiency.

Dynamic power efficiency is a ratio of computational performance (e.g., throughput and/or clock frequency achievable by an SoC) to dynamic power consumption, e.g., power consumed by an SoC when transistors in the circuitry of the SoC are actively switching states. Static power consumption refers to power consumed in an SoC when the transistors in the circuitry of the SoC are not actively switching states. In other words, dynamically power efficient SoCs are able to achieve increased computational performance and/or decreased power consumption when in active utilization states because dynamic power consumption is the primary source of power consumption for an SoC in active utilization. Further, dynamically power inefficient SoCs are able to achieve decreased power consumption in idle and near-idle utilization states because static power consumption is the primary source of power consumption for an SoC in idle and near-idle utilization. Compute nodes inherit the computational performance and power consumption characteristics of the SoCs contained therein.

Conventional techniques for work distribution in a data center, however, do not utilize the computational performance and power consumption characteristics of individual compute nodes when distributing work to the compute nodes. Accordingly, the techniques described herein relate to exposing the variable computational performance and power consumption characteristics of individual execution nodes to a scheduler of the management node, which distributes software processes (e.g., applications, virtual machines, and/or portions thereof) to the execution nodes based on these characteristics.

As part of this, an execution node generates an efficiency metric by observing computational performance (e.g., throughput and/or clock frequency), dynamic power consumption, and static power consumption exhibited by the execution node. The efficiency metric has a direct relationship with both dynamic power efficiency and static power consumption. For instance, the execution node increases the efficiency metric in response to observing increased dynamic power efficiency and/or increased static power consumption. Furthermore, the execution node periodically writes the efficiency metric to a register of the management node associated with the execution node. This process is repeated by each execution node of the plurality of execution nodes, resulting in a plurality of registers indicating efficiency metrics of respective execution nodes.

Here, the scheduler (e.g., running on a processor, such as a central processing unit (CPU), of the management node) reads the efficiency metrics of the execution nodes from the registers, and distributes software processes to be executed by the execution nodes based on the efficiency metrics. In one example, the scheduler prioritizes execution of software processes on execution nodes associated with increased efficiency metrics and deprioritizes execution of software processes on execution nodes associated with decreased efficiency metrics. This enables dynamically power efficient execution nodes to execute software processes with increased computational performance and/or decreased power consumption, and also reduces power consumption for the data center by transferring work away from dynamically power inefficient execution nodes. This prioritization protocol often causes dynamically power inefficient execution nodes to operate in idle and near-idle utilization states (e.g., reserving these nodes for future scale out operations), thereby leveraging the decreased static power consumption associated with these nodes.

Furthermore, the scheduler distributes multi-node software processes to multiple execution nodes in a manner that reduces performance variance across the multiple execution nodes. Indeed, multi-node software processes often have global synchronization requirements which invoke blocking for compute nodes exhibiting significant performance variance, e.g., scenarios in which faster compute nodes wait until a slowest compute node completes a task before proceeding. The described techniques alleviate this scenario in various ways. For instance, the scheduler distributes a multi-node software process to multiple execution nodes having efficiency metrics within a defined range of one another (e.g., exhibiting similar computational performance characteristics), adjusts power consumption at the multiple execution nodes to normalize computational performance, and/or adjusts amounts of work within workloads allocated to the multiple execution nodes to normalize an amount of time to process the workloads by the multiple execution nodes. By alleviating blocking scenarios, the described techniques increase the speed at which multi-node software processes run, and increase a ratio of execution nodes that are occupied performing useful work, which increases computational performance of the data center as a whole.

In summary, the described techniques achieve increased computational performance and/or decreased computational performance for the data center as a whole by leveraging variable computational performance and power consumption characteristics of individual execution nodes. This is not possible for conventional techniques because conventional work distribution mechanisms are not exposed to information regarding a compute node's individual performance and power consumption characteristics. Given that power consumption is often a data center's largest cost, the power savings of the described techniques consequently reduce a total cost of ownership (TCO) associated with the data center.

In some aspects, the techniques described herein relate to a system comprising a plurality of compute nodes including a management node and a plurality of execution nodes, the management node having a processor configured to read, from one or more registers of the management node, efficiency metrics associated with respective execution nodes of the plurality of execution nodes, and distribute software processes among the plurality of execution nodes for execution based on the efficiency metrics.

In some aspects, the techniques described herein relate to a system, wherein the efficiency metrics are directly related to dynamic power efficiency and static power consumption of the respective execution nodes.

In some aspects, the techniques described herein relate to a system, wherein the efficiency metrics are a function of one or more of ages of the respective execution nodes, local temperatures of the respective execution nodes, and historical usage amounts of the respective execution nodes.

In some aspects, the techniques described herein relate to a system, wherein an efficiency metric of a respective execution node includes multiple fields indicating different categories of computational performance and power consumption characteristics, wherein the multiple fields include two or more of a first field indicating idle power efficiency of the respective execution node, two or more second fields indicating the computational performance and power consumption characteristics of the respective execution node while executing different types of the software processes, one or more third fields indicating an age and a historical amount of usage of the respective execution node, and a fourth field indicating a local temperature of the respective execution node.

In some aspects, the techniques described herein relate to a system, wherein the processor is configured to reserve an execution node for future scale out operations of the software processes based on an efficiency metric of the execution node falling below a threshold.

In some aspects, the techniques described herein relate to a system, wherein the processor is configured to distribute a low utilization software process to a low efficiency execution node having an efficiency metric that is below a first threshold, the low utilization software process estimated to invoke a resource utilization ratio that is below a second threshold at the low efficiency execution node.

In some aspects, the techniques described herein relate to a system, wherein the processor is configured to distribute a high utilization software process to a high efficiency execution node having an efficiency metric that exceeds a first threshold, the high utilization software process estimated to invoke a resource utilization ratio that exceeds a second threshold at the high efficiency execution node.

In some aspects, the techniques described herein relate to a system, wherein the processor is configured to issue one or more migration instructions causing migration of a software process from a first execution node to a second execution node responsive to resource utilization at the plurality of execution nodes having decreased, a first efficiency metric of the first execution node being less than a second efficiency metric of the second execution node.

In some aspects, the techniques described herein relate to a system, wherein the processor is configured to classify a software process as a critical software process, and distribute the critical software process to a high efficiency execution node having an efficiency metric that exceeds a threshold.

In some aspects, the techniques described herein relate to a system, wherein the processor is configured to distribute a multi-node software process to multiple execution nodes having the efficiency metrics within a defined range of one another.

In some aspects, the techniques described herein relate to a system, wherein the processor is configured to distribute a multi-node software process to multiple execution nodes by adjusting amounts of work within workloads of the multi-node software process allocated to the multiple execution nodes based on the efficiency metrics to normalize an amount of time to process the workloads by the multiple execution nodes.

In some aspects, the techniques described herein relate to a system, wherein the processor is configured to distribute a multi-node software process to multiple execution nodes by adjusting power consumption of the multiple execution nodes based on the efficiency metrics to normalize computational performance across the multiple execution nodes.

In some aspects, the techniques described herein relate to a system comprising a plurality of compute nodes including a management node and a plurality of execution nodes, an execution node of the plurality of compute nodes configured to populate a register of the management node with an efficiency metric of the execution node, and receive a software process from the management node for execution based on the efficiency metric.

In some aspects, the techniques described herein relate to a system, wherein the efficiency metric is directly related to dynamic power efficiency and static power consumption of the execution node.

In some aspects, the techniques described herein relate to a system, wherein the software process is a low utilization software process estimated to invoke a resource utilization ratio below a first threshold at the execution node, and the low utilization software process is received based on the efficiency metric falling below a second threshold.

In some aspects, the techniques described herein relate to a system, wherein the software process is a high utilization software process estimated to invoke a resource utilization ratio that exceeds a first threshold at the execution node, and the high utilization software process is received based on the efficiency metric exceeding a second threshold.

In some aspects, the techniques described herein relate to a method comprising reading, by a management node, efficiency metrics of a plurality of execution nodes from one or more registers of the management node, the efficiency metrics having multiple fields indicating different categories of computational performance and power consumption characteristics of the plurality of execution nodes, and distributing by the management node, software processes to the plurality of execution nodes for execution based on the efficiency metrics.

In some aspects, the techniques described herein relate to a method, wherein the multiple fields include a field indicating idle power efficiencies of the plurality of execution nodes, and distributing the software processes includes reserving an execution node for future scale out operations of the software processes based, in part, on an idle power efficiency of the execution node exceeding a threshold.

In some aspects, the techniques described herein relate to a method, wherein the multiple fields include a field indicating compute-intensive power efficiencies of the plurality of execution nodes while executing compute-intensive software processes, and distributing the software processes includes distributing a compute-intensive software process to an execution node based, in part, on a compute-intensive power efficiency of the execution node exceeding a threshold.

In some aspects, the techniques described herein relate to a method, wherein the multiple fields include a field indicating communication-intensive power efficiencies of the plurality of execution nodes while executing communication-intensive software processes, and distributing the software processes includes distributing a communication-intensive software process to an execution node based, in part, on a communication-intensive power efficiency of the execution node exceeding a threshold.

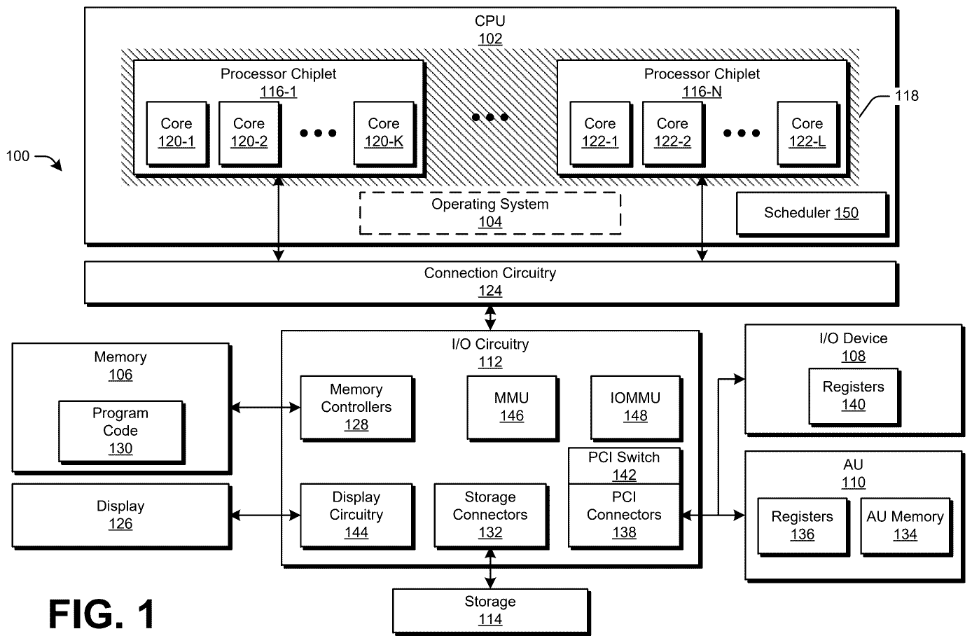

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

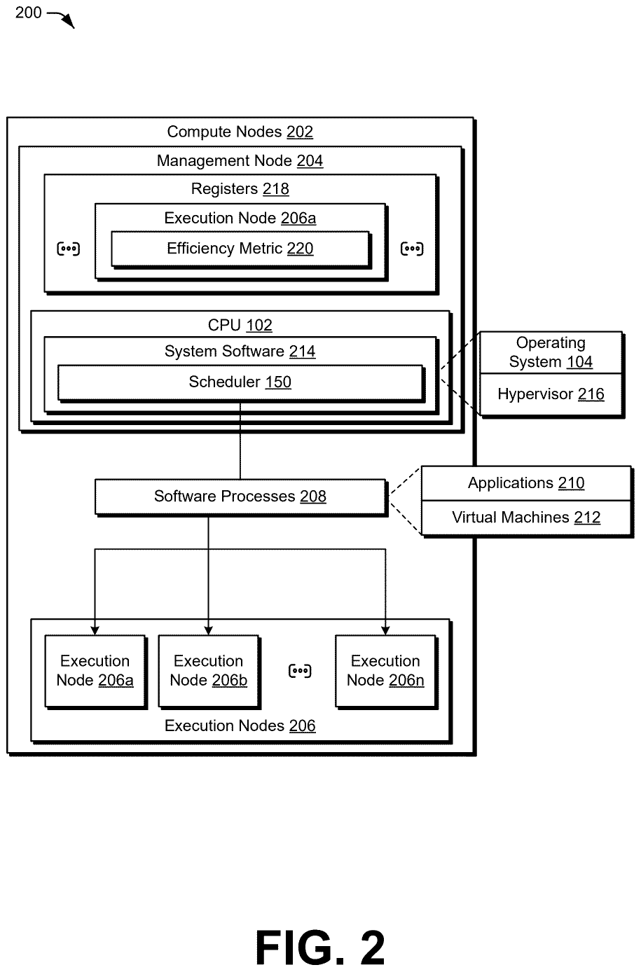

In this example, a scheduler 150 is depicted in the CPU 102. As further discussed below with reference to FIG. 2, the scheduler 150 is configured to distribute software processes (e.g., applications) to compute nodes of a data center or large scale deployment based on efficiency metrics associated with the compute nodes. In variations, however, the scheduler 150 is included in and/or is implemented by one or more different components of the processing system 100, such as the memory 106, the I/O device 108, the AU 110, the I/O circuitry 112, the storage 114, and so forth. In at least one specific but non-limiting implementation, the scheduler 150 is implemented by the OS 104 of the CPU 102.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2 , 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

In one or more non-limiting examples, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

FIG. 2 is a block diagram of a non-limiting example system 200 to implement work distribution in a data center based on compute node efficiency. In various examples, the system 200 is a data center including a plurality of compute nodes 202. As shown, the plurality of compute nodes 202 includes a management node 204, and a plurality of execution nodes 206, e.g., execution nodes 206a, 206b, 206n. The plurality of compute nodes 202 are coupled to one another via wired or wireless connections. Examples of wired connections include but are not limited to including ethernet cables, fiber optic cables, InfiniBand cables, Direct Attached Copper (DAC) cables, and Twinax Cables.

The plurality of compute nodes 202 are implementable in a variety of ways. By way of example, a compute node 202 represents multiple server computers, a single server computer, multiple systems-on-chips (SoCs), a single SoC, multiple processors, a single processor, multiple processor cores of a single processor, or a single processor core of a single processor. Therefore, the compute nodes 202 range in processing capabilities and hardware complexity from relatively simple (e.g., a single processor core) to relatively complex, e.g., multiple server computers. In at least one specific but non-limiting example, each compute node 202 is representative of a server computer having one or more SoCs.

For instance, the processing system 100 of FIG. 1 is an example of an SoC. Given this, the management node 204 is a server computer including one or more instances of the processing system 100, with at least one instance of the processing system 100 running the scheduler 150 on the CPU 102, as illustrated. Similarly, the execution nodes 206 are server computers including one or more instances of the processing system 100, but the execution nodes 206 do not include the scheduler 150 and/or are not actively running the scheduler 150.

Broadly, the management node 204 is configured to manage execution of software processes 208 by scheduling and dispatching the software processes 208 for execution by the execution nodes 206. As shown, examples of the software processes 208 include applications 210 and virtual machines 212. Broadly, applications 210 are software programs (e.g., sets of instructions) which when executed in hardware (e.g., by a processor) perform specific tasks and/or functions. In contrast, virtual machines 212 are software emulations of physical computers that each run an operating system and one or more applications 210 in an isolated execution environment. Virtual machines 212 allow multiple instances of an operating system to run on a single physical machine (e.g., a single compute node 202), thereby improving flexibility, scalability and resource utilization for the system 200.

As shown, the management node 204 includes the CPU 102 which is an electronic circuit configured to run system software 214 that manages the execution of the software processes 208, e.g., the applications 210 and/or the virtual machines 212. Broadly, the system software 214 is configured to allocate hardware resources (e.g., the execution nodes 206 or portions thereof) to respective software processes 208. As part of this, the system software 214 includes the scheduler 150 which is a software program configured to schedule and distribute the software processes 208 to respective execution nodes 206 for execution. Examples of the system software 214 include the operating system 104 for managing execution of the applications 210 on the execution nodes 206, and a hypervisor 216 for managing execution of the virtual machines 212 on the execution nodes 206.

In various examples, the scheduler 150 distributes multiple software processes 208 for execution on a single execution node 206, dedicates a single execution node 206 for the purpose of executing a single software process 208, and distributes a single software process 208 to be executed by multiple execution nodes 206. In certain implementations, for instance, the scheduler 150 divides a software process 208 into individual tasks or subsets of tasks and distributes portions of the software process 208 to different execution nodes 206. Thus, references made herein to distributing software processes 208 to the execution nodes 206 additionally or alternatively refers to distributing portions of the software processes 208 to the execution nodes 206.

As mentioned above, the compute nodes 202 each include one or more SoCs in various examples. Due to normal variations in physical characteristics of SoCs resulting from the SoC fabrication process, different SoCs exhibit different computational performance and power consumption characteristics. By way of example, some SoCs are capable of achieving the same clock frequency (e.g., which is highly correlated to computational performance) as other SoCs, but do so while utilizing a lower supply voltage. This is known as dynamic power efficiency, which is a ratio of computational performance (e.g., measured in throughput, such as instructions or operations executed per second, or clock frequency) to dynamic power consumption. Dynamic power inefficient SoCs, however, often exhibit decreased static power consumption as compared to dynamic power efficient SoCs. Given this, dynamic power inefficient SoCs consume less power when there is little activity on the chip, e.g., when the chip is in an idle or near-idle utilization state. Different compute nodes 202 inherit the different computational performance and power consumption characteristics of the SoCs contained therewithin.

Notably, dynamic power consumption refers to power consumed in a digital circuit (e.g., an SoC within a compute node 202) when the transistors in the digital circuit are actively switching states. Dynamic power consumption is caused by charging and discharging capacitive loads during state transitions. Further, static power consumption refers to power consumed in a digital circuit (e.g., an SoC within a compute node 202) when the transistors are not actively switching states. Static power consumption results from leakage currents that flow through transistors of the digital circuit even when the transistors are switched off. When an execution node 206 is in an active state, dynamic power consumption is the primary source of power consumption for the execution node 206. Contrarily, when the execution node 206 is in an idle utilization state (e.g., the execution node 206 is not performing any processing tasks) or near-idle utilization state (e.g., the execution node 206 is performing processing tasks, such as background processing tasks, but resource utilization at the execution node is low and/or below a threshold), static power consumption is the primary source of power consumption for the execution node 206.

Conventional techniques for distributing work in a data center, however, fail to take advantage of these computational performance and power consumption variabilities to optimize computational performance and power consumption for the system. One such conventional technique involves guaranteeing similar computational performance (e.g., throughput or clock frequency within a specified range) across all compute nodes in a system. In accordance with this conventional technique, however, a least efficient compute node reaches full socket power consumption at a particular computational performance, and the remaining compute nodes are limited to running at the particular computational performance, thereby severely hindering performance of the system as a whole. Notably, the socket power of a compute node is a total amount of power supplied to the compute node, and as such, power consumption at the compute node cannot exceed the socket power, e.g., the socket power is a maximum power capacity for the compute node.

In another conventional technique, different compute nodes are able to operate at varying computational performance levels and clock frequencies, e.g., each compute node can utilize its full socket power. However, this technique fails to utilize the different computational performance and power consumption characteristics of specific compute nodes to guide work distribution decisions. In other words, this technique simply allows each compute node to operate at its full socket power without considering which compute nodes exhibit increased dynamic power efficiency, and which compute nodes exhibit decreased static power consumption. As a result, a conventionally-configured system distributes work in a manner that leads to suboptimal computational performance and power consumption for the system as a whole.

Accordingly, techniques are described herein for work distribution in a data center based on compute node efficiency. In accordance with the described techniques, the management node 204 includes a plurality of registers 218, e.g., hardware registers. The registers 218 include an efficiency metric 220 for each execution node 206 of the plurality of execution nodes 206, as shown. Broadly, the efficiency metric 220 of a respective execution node 206 captures the computational performance and power consumption characteristics of the respective execution node 206.

Here, an execution node 206 is configured to generate an efficiency metric 220 by observing the clock frequency, the computational performance (e.g., measured in throughput, such as instructions or operations executed per second), the dynamic power consumption, and the static power consumption exhibited by the execution node 206. Generally, the execution node 206 increases the efficiency metric 220 in response to observing increased dynamic power efficiency and increased static power consumption. In other words, the efficiency metric 220 is directly related (e.g., rather than inversely related) to dynamic power efficiency and static power consumption. In one or more implementations, the execution node 206 writes the efficiency metric 220 to the registers periodically (e.g., every hour, every four hours, every day, etc.) based on the observed dynamic power efficiency and static power consumption during the preceding time period. This process is repeated by each execution node 206 of the plurality of execution nodes 206, and as a result, the registers 218 include the efficiency metrics 220 of each execution node 206.

Different execution nodes 206 are associated with different efficiency metrics 220. This is a result of the static physical differences of SoCs contained within the different execution nodes 206 resulting from the SoC fabrication process, as well as various dynamic factors. These dynamic factors that impact the efficiency metrics 220 include local temperature of the execution nodes 206, ages of the execution nodes 206, and historical amounts of use of the execution nodes 206. By way of example, an execution node 206 associated with an increased age, increased historical usage, and an increased local temperature exhibits increased power consumption, e.g., both static and dynamic power consumption. This also reduces the clock frequency and computational performance achievable by the execution node 206 given a constant power consumption value.

In at least one example, the execution nodes 206 directly consider the age, historical usage, and local temperature of respective execution nodes 206 when generating the efficiency metrics 220, e.g., the age, historical usage, and local temperature are terms of an algorithm for calculating the efficiency metrics 220. Additionally or alternatively, the execution nodes 206 indirectly consider the age, historical usage, and local temperature of respective execution nodes 206 when generating the efficiency metrics 220. For instance, the execution nodes 206 generate the efficiency metric 220 based on the observed dynamic power efficiency and static power consumption, which are impacted by the age, historical usage, and local temperature. Regardless, the factors impacting the efficiency metric 220 of a respective execution node 206 include computational performance (e.g., throughput), dynamic power consumption, static power consumption, voltage supplied to the respective execution node 206 and the resulting clock frequency, as well as the age, historical usage, and local temperature of the respective execution node 206.

In accordance with the described techniques, the CPU 102 reads the efficiency metrics 220 from the registers 218, and the scheduler 150 distributes the software processes 208 to respective execution nodes 206 based on the efficiency metrics 220. As part of this, the scheduler 150 reserves one or more execution nodes 206 as reserve nodes for future scale out operations of the software processes 208. Scaling out (e.g., horizontal scaling of) a software process 208 refers to the process of allocating additional execution nodes 206 to execute the software process 208, e.g., in order to increase computational speed or handle increased computational load. In one or more implementations, the reserve nodes are the execution nodes 206 having efficiency metrics falling below a reservation threshold.

In at least one example, the reservation threshold is defined such that the reserve nodes represent a particular number or a particular percentage of the execution nodes 206 associated with the lowest efficiency metrics 220 among the plurality of execution nodes 206. In one or more implementations, the system software 214 and/or the scheduler 150 dynamically define and redefine the reservation threshold based on a current state of the system 100, e.g., based on a current set of values of the efficiency metrics 220 for the execution nodes 206. As part of reserving the inefficient execution nodes 206 as reserve nodes, the scheduler 150 distributes the software processes 208 to other non-reserved execution nodes 206 (having relatively higher efficiency metrics 220) for execution, and refrains from distributing the software processes 208 to the reserve nodes. However, the reserve nodes are available to be allocated to software processes 208 that are expected to utilize scale out architecture.

By reserving the low efficiency execution nodes 206 for scale out operations, the described techniques reduce power consumption and increase computational performance for the system 200. Since the reserve nodes exhibit decreased static power consumption and are frequently kept in idle and near-idle utilization states (in which static power consumption is the primary source of power consumption), the described techniques reduce static power consumption for the system 200. Moreover, the non-reserved nodes exhibiting improved dynamic power efficiency are utilized for actively executing the software process 208. This reduces dynamic power consumption and/or increases computational performance in comparison to executing the software processes 208 on the reserve nodes.

In another example, the scheduler 150 is configured to distribute the software processes 208 to the execution nodes 206 based on resource utilization ratios of the software processes 208. As part of this, the system software 214 is configured to estimate resource utilization ratios for the software processes 208. The resource utilization ratio of a software process 208 refers to a percentage of the hardware resources expected to be invoked at a respective execution node 206 by running the software process 208. For example, the resource utilization ratio of a software process 208 is based on one or more of: (1) a percentage of total processing (e.g., CPU and/or GPU) capacity of the respective execution node 206 expected to be invoked by the software process 208, (2) a percentage of total memory (e.g., cache memory, volatile memory, non-volatile memory, and/or secondary storage) capacity of the respective execution node 206 expected to be invoked by the software process 208, and (3) a percentage of total network/communication bandwidth capacity of the respective execution node 206 expected to be invoked by the software process 208. It should be noted that the total processing capacity, the total memory capacity, and the total network/communication bandwidth capacity of a respective execution node 206 is dependent on the clock frequency at which the respective execution node 206 is operating.

The system software 214 is configured to estimate the resource utilization ratio of a software process 208 in various ways. In one example, the system software monitors resource usage of the execution nodes 206 during execution of previous instances of the software process 208. Further, the system software 214 determines the resource utilization ratio of the software process 208 by calculating an average resource utilization ratio invoked at the execution nodes 206 during previous execution instances of the software process 208. Additionally or alternatively, the system software 214 estimates the resource utilization ratio of a software process 208 by analyzing the instructions of the software process 208 and calculating a processing load, a memory load, and/or a communication load required to execute the software process 208.

In accordance with the described techniques, the system software 214 classifies, as low utilization software processes 208, software processes 208 having resource utilization ratios that are below a node utilization threshold. Furthermore, the system software 214 classifies, as high utilization software processes 208, the software processes 208 having resource utilization ratios that exceed or equal the node utilization threshold. In one or more implementations, the system software 214 and/or the scheduler 150 dynamically define and redefine the node utilization threshold based on a current state of the system 200, e.g., based on a current average resource utilization exhibited at the execution nodes 206.

In addition, the system software 214 classifies, as low efficiency execution nodes 206, the execution nodes 206 having efficiency metrics 220 that fall below an efficiency threshold. Moreover, the system software 214 classifies, as high efficiency execution nodes 206, the execution nodes 206 having efficiency metrics that exceed or equal the efficiency threshold. Given this, the scheduler 150 distributes the low utilization software processes 208 to the low efficiency execution nodes 206, and distributes the high utilization software processes 208 to the high efficiency execution nodes 206. In one or more implementations, the system software 214 and/or the scheduler 150 dynamically define and redefine the efficiency threshold based on a current state of the system 200, e.g., based on a current set of values of the efficiency metrics 220 for the execution nodes 206.

Additionally or alternatively, the system software 214 ranks software processes 208 that are ready for dispatch based on the resource utilization ratios of the software processes 208. By way of example, the system software 214 ranks software processes 208 from highest resource utilization ratio to lowest resource utilization ratio estimated to be invoked at the execution nodes 206. Furthermore, the system software 214 identifies a plurality of available execution nodes 206 that are available for executing the top-ranked software process 208. For instance, the available execution nodes 206 are not executing software processes 208 and/or have sufficient available resources to execute the top-ranked software process 208. Further, the scheduler 150 dispatches the top-ranked software process 208 to an execution node 206 having a highest efficiency metric 220 among the available execution nodes 206. This process is repeated iteratively to dispatch successively ranked software processes 208 (exhibiting progressively lower utilization ratios) to available execution nodes 206 having progressively lower efficiency metrics 220.

By distributing the lower utilization software processes 208 to less efficient execution nodes 206, the described techniques reduce dynamic power consumption at the less efficient execution nodes 206, which reduces power consumption for the system 200 as a whole. Moreover, executing the higher utilization software processes 208 at the more efficient execution nodes 206 improves computational performance and/or reduces dynamic power consumption in comparison to executing the higher utilization software processes 208 at the less efficient execution nodes 206. In various scenarios, the high utilization software processes 208 invoke utilization of full socket power at the high efficiency execution nodes 206. Since the high efficiency execution nodes 206 achieve increased computational performance (e.g., throughput and/or clock frequency) at a constant dynamic power consumption (e.g., full socket power), executing these software processes at the high efficiency execution nodes 206 further improves computational performance for the system 200.

In yet another example, the scheduler 150 issues migration instructions causing migration of a software process 208 between execution nodes 206 based on total resource utilization at the plurality of execution nodes 206. In certain examples, resource utilization or resource demand at the plurality of execution nodes 206 fluctuates. Indeed, all execution nodes 206 are utilized to meet an elevated resource demand at certain times, and one or more execution nodes 206 operate in idle or near-idle utilization states at other times based on a reduced resource demand. Here, the system software 214 detects a decrease in total resource utilization at the plurality of execution nodes 206. In one or more example, the decrease in total resource utilization is detected as one or more execution nodes 206 having transitioned from active utilization states to idle or near-idle utilization states.

In response to detecting the reduction in resource utilization at the execution nodes 206, the scheduler 150 issues migration instructions to one or more first execution nodes 206. The migration instructions cause the one or more first execution nodes 206 to communicate software processes 208 that are currently running on the one or more first execution nodes 206 to one or more second execution nodes 206 before the software processes 208 have finished executing. In accordance with the described techniques, the one or more second execution nodes 206 have increased efficiency metrics 220 relative to the efficiency metrics 220 of the one or more first execution nodes 206. Given this, the one or more second execution nodes 206 receive the software processes 208, and complete execution of the software processes 208. In other words, the scheduler 150 issues instructions which cause migration or movement of a software process 208 from a less efficient execution node 206 to a more efficient execution node 206 based on total resource utilization at the plurality of execution nodes 206 having decreased.

By migrating software processes 208 away from the less efficient execution nodes 206, the described techniques reduce dynamic power consumption at the less efficient execution nodes 206, which reduces dynamic power consumption for the system 200 as a whole. In one or more scenarios, migration in the described manner places the less efficient execution nodes 206 in idle or near-idle utilization states. Since the less efficient execution nodes 206 consume less power in these utilization states than the more efficient execution nodes 206, the described migration techniques further reduce static power consumption for the system 200. Furthermore, by migrating the software processes 208 to the more efficient execution nodes 206, the software processes 208 are executed with increased computational performance and/or decreased dynamic power consumption.

In another example, the system software 214 is configured to classify one or more software processes 208 as critical software processes 208 based on service level agreements (SLAs) of the software processes 208. SLAs of a software process 208 are contracts which specify computational performance metrics that are guaranteed to be met when executing the software process 208 on the execution nodes 206 of the data center. Given this, the system software 214 identifies critical software processes 208 including SLAs which define guaranteed performance metrics that exceed various defined thresholds. In one example of throughput as a performance metric specified in SLAs of a software process 208, the system software 214 classifies the software process 208 as a critical software process 208 based on the throughput specified in the SLAs exceeding a throughput threshold.

Here, the scheduler 150 is configured to distribute the critical software processes 208 for execution on high efficiency execution nodes 206 having efficiency metrics 220 that exceed or equal a critical execution threshold. In one or more implementations, the system software 214 and/or the scheduler 150 dynamically define and redefine the critical execution threshold for different critical software processes 208 based on the performance metrics of the SLAs associated with the different critical software processes 208. By executing the critical software processes 208 on dynamically power efficient execution nodes 206, the described techniques ensure that the SLAs of the critical software processes 208 are met.

In various examples, the scheduler 150 is configured to distribute a multi-node software process 208 for execution by multiple execution nodes 206. By way of example, a multi-node software process 208 is a software process 208 having a resource utilization ratio that exceeds a resource utilization threshold. Software processes 208 that are estimated to invoke resource utilization above the resource utilization threshold are precluded from efficiently being executed on a single execution node 206. To execute a multi-node software process 208, multi-threading techniques are utilized to create multiple threads of execution each leveraging the hardware resources of a different subset of one or more execution nodes 206. Given this, different threads execute different portions (e.g., different sets of tasks) of the multi-node software processes 208.

However, multi-node software processes 208 have global synchronization requirements, in various implementations. For instance, a global synchronization point is a moment during execution of the multi-node software process 208 at which all threads involved in executing the multi-node software process 208 are to reach a certain execution stage before any of the threads can proceed. This can lead to blocking scenarios in which threads exhibiting increased computational performance wait until other threads exhibiting decreased computational performance complete execution of certain tasks. In other words, performance variance across threads (subsets of one or more execution nodes 206) in a cluster of multiple execution nodes 206 involved in executing a multi-node software process 208 can lead to blocking scenarios, which increases an amount of time to execute the multi-node software process 208.

Accordingly, a goal of the described techniques is to reduce performance variance across threads in a cluster, which is achieved in any one or more of a variety of ways. In the following discussion, examples are described in which each execution node 206 represents a single thread of execution, and performance variance is reduced across individual execution nodes 206 involved in executing the multi-node software process 208. However, it is to be appreciated that the described techniques are extendable to reduce performance variance across threads that include two or more execution nodes 206.

In one example, the scheduler 150 is configured to distribute a multi-node software process 208 to multiple execution nodes 206 having efficiency metrics 220 within a defined range of one another. By way of example, a difference between a lowest efficiency metric 220 of the multiple execution nodes 206 and a highest efficiency metric 220 of the multiple execution nodes 206 is less than a variance threshold. Since the efficiency metrics 220 are directly related to computational performance, execution nodes 206 having similar efficiency metrics 220 (e.g., within the defined range) exhibit similar computational performance. In one or more implementations, the system software 214 and/or the scheduler 150 dynamically define and redefine the variance threshold for different multi-node software processes 208 based on performance metrics of SLAs of the different multi-node software processes 208. By distributing the multi-node software process 208 to the execution nodes 206 exhibiting similar computational performance, the described techniques alleviate and reduce instances of blocking, which improves computational performance for the system 200 as a whole.

Additionally or alternatively, the scheduler 150 is configured to distribute a multi-node software process 208 to multiple execution nodes 206, and adjust amounts of work within workloads of the multi-node software process 208 allocated to the multiple execution nodes 206 to normalize an amount of time to process the workloads by the multiple execution nodes 206. Consider an example in which a first execution node 206 having a first efficiency metric 220 and a second execution node 206 having a second efficiency metric 220 are involved in executing the multi-node software process 208. In this example, the first efficiency metric 220 is greater than the second efficiency metric 220. Accordingly, the scheduler 150 allocates increased computational load of the multi-node software process 208 to the first execution node 206 and/or allocates decreased computational load of the multi-node software process 208 to the second execution node 206. The computational loads supplied to the first and second execution nodes 206 are in amounts which cause the first and second execution nodes 206 to execute respective workloads in substantially similar amounts of time.

Notably, processing time is a function of the efficiency metric 220 of an execution node 206 and the computational load allocated to an execution node 206. For instance, processing time is inversely related to the efficiency metric 220 (e.g., the processing time decreases as the efficiency metric 220 increases), and is directly related to computational load, e.g., the processing time increases as the computational load increases. Thus, the scheduler 150 adjusts computational load allocated to the multiple execution nodes 206 based on the efficiency metrics 220 of the multiple execution nodes 206 to balance estimated processing times for the multiple execution nodes 206 to process respective workloads allocated thereto. By doing so, the described techniques alleviate and reduce instances of blocking, which improves computational performance for the system 200 as a whole.

In yet another example, the scheduler 150 is configured to distribute a multi-node software process 208 to multiple execution nodes 206, and adjust power consumption at the multiple execution nodes 206 to normalize computational performance across the multiple execution nodes 206. Consider an example in which a first execution node 206 having a first efficiency metric 220 and a second execution node 206 having a second efficiency metric 220 are involved in executing the multi-node software process 208. In this example, the first efficiency metric 220 is greater than the second efficiency metric 220. Accordingly, the scheduler 150 issues one or more instructions to the first execution node 206 causing the first execution node to decrease power consumption. Additionally or alternatively, the scheduler 150 issues one or more instructions to the second execution node 206 instructing the second execution node 206 to increase power consumption. The different power consumptions of the first and second execution nodes 206 are set at levels which cause the first and second execution nodes to operate at substantially similar computational performance, e.g., throughput and/or clock frequency.

Notably, computational performance is a function of the efficiency metric 220 of an execution node 206 and the power consumed by the execution node 206. For instance, computational performance is directly related to the efficiency metric 220 and power consumption, e.g., computational performance increases as the efficiency metric 220 and power consumption increases. Thus, the scheduler 150 adjusts the amount of power to be allocated to the multiple execution nodes 206 based on the efficiency metrics 220 of the multiple execution nodes 206 in order to balance estimated throughput and/or clock frequencies achievable by the multiple execution nodes 206. By doing so, the described techniques alleviate and reduce instances of blocking, which improves computational performance for the system 200 as a whole.

In contrast to conventional techniques, the described techniques expose efficiency metrics 220 capturing power consumption and computational performance characteristics of individual execution nodes 206 to the system software 214 and scheduler 150 via the registers 218. This enables the scheduler 150 to distribute software processes 208 based on the specific computational performance and power consumption characteristics exhibited by the execution nodes 206. Generally, this enables the described techniques to distribute and migrate software processes 208 to more efficient execution nodes 206, which reduces dynamic power consumption and increases computational performance when executing the software processes 208. In addition, the power consumption of less efficient execution nodes 206 are decreased, which also reduces power consumption for the system 200 as a whole. Furthermore, the execution nodes 206 exhibiting decreased static power consumption are reserved as reserve nodes frequently operating in idle or near-idle utilization states, which also reduces system power consumption. Finally, the described techniques reduce performance variance across multiple threads and/or execution nodes involved in executing a multi-node software process 208, which improves computational performance for the system 100.

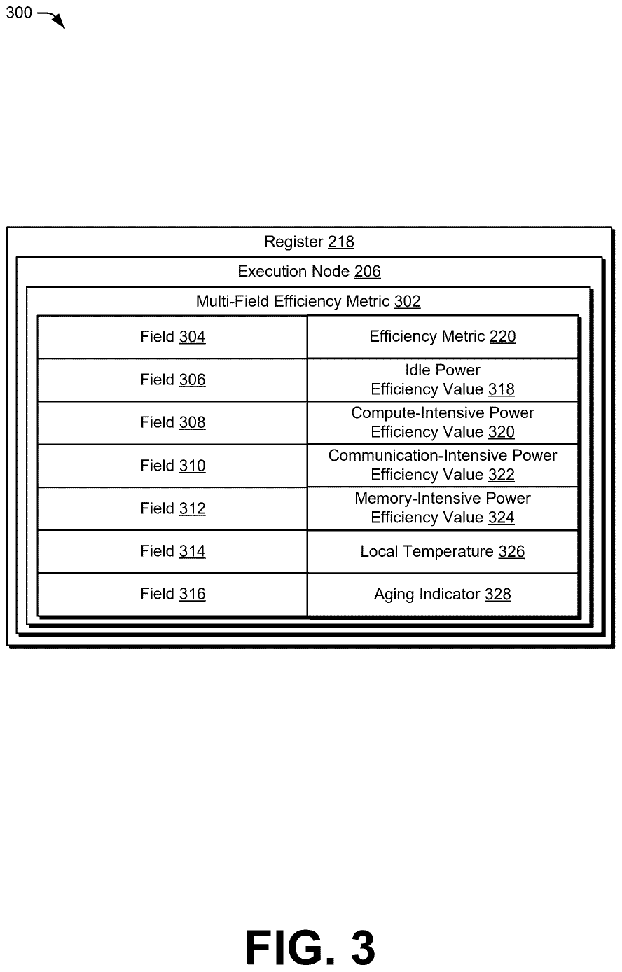

FIG. 3 depicts an example 300 of an efficiency metric of an execution node having multiple fields indicating different categories of computational performance and power consumption characteristics. As shown, the example 300 includes a multi-field efficiency metric 302 having a plurality of fields 304, 306, 308, 310, 312, 314, 316 written to a register 218 of the management node 204. The register 218 is associated with a particular execution node 206 of the plurality of execution nodes 206. In one or more implementations, the register 218 includes a particular number of bits. Further, specific ranges of bits within the register 218 correspond to different fields 304, 306, 308, 310, 312, 314, 316, which when populated specify the different computational performance and power consumption characteristics associated with the particular execution node 206.

In particular, the multi-field efficiency metric 302 includes a first field 304 indicating the efficiency metric 220 of the execution node 206 as discussed above with reference to FIG. 2. As previously mentioned, the efficiency metric 220 is directly related to dynamic power efficiency and static power consumption of the execution node 206. Furthermore, the execution node 206 generates the efficiency metric 220 based on the computational performance (e.g., throughput and/or clock frequency), dynamic power consumption, and static power consumption exhibited by the execution node 206 while executing software processes 208 of all types.

Furthermore, the multi-field efficiency metric 302 includes a second field 306 indicating an idle power efficiency value 318 of the execution node 206. The idle power efficiency value 318 represents a degree of static power consumption exhibited by the execution node 206. For instance, the idle power efficiency value 318 represents a degree to which the execution node 206 consumes power when the execution node 206 is in an idle or near-idle utilization state. The execution node 206 generates the idle power efficiency value 318 based on static power consumption exhibited by the execution node 206. For example, the idle power efficiency value 318 increases as static power consumption of the execution node 206 decreases, e.g., an inverse relationship. In particular, the execution node 206 generates the idle power efficiency value 318 based on observed leakage currents exhibited at the chiplets (e.g., the chiplets 116 of the execution node 206) and I/O dice (e.g., the I/O circuitry 112) of the one or more SoCs contained within the execution node 206.

Additionally, the multi-field efficiency metric 302 includes a third field 308 indicating a compute-intensive power efficiency value 320 of the execution node 206. In accordance with the described techniques, the system software 214 marks software processes 208 as compute-intensive software processes 208 based on the software processes 208 being estimated to invoke at least a threshold amount of processing resources at the execution nodes 206. Given this, the execution node 206 generates the compute-intensive power efficiency value 320 based on the computational performance (e.g., clock frequency and/or throughput) and dynamic power consumption exhibited by the execution node 206 when executing the compute-intensive software processes 208. Like the efficiency metric 220, the compute-intensive power efficiency value 320 is directly related to dynamic power efficiency of the execution node 206. However, unlike the efficiency metric 220, the compute-intensive power efficiency value 320 is computed based on the observed power consumption and computational performance characteristics of the execution node 206 while executing compute-intensive software processes 208, and not other types of software processes 208.

Moreover, the multi-field efficiency metric 302 includes a fourth field 310 indicating a communication-intensive power efficiency value 322 of the execution node 206. In accordance with the described techniques, the system software 214 marks software processes 208 as communication-intensive software processes 208 based on the software processes 208 being estimated to invoke at least a threshold amount of network/communication bandwidth at the execution node 206. Given this, the execution node 206 generates the communication-intensive power efficiency value 322 based on the computational performance (e.g., clock frequency and/or throughput) and dynamic power consumption exhibited by the execution node 206 when executing the communication-intensive software processes 208. Like the efficiency metric 220, the communication-intensive power efficiency value 322 is directly related to dynamic power efficiency of the execution node 206. However, unlike the efficiency metric 220, the communication-intensive power efficiency value 322 is computed based on the observed power consumption and computational performance characteristics of the execution node 206 while executing communication-intensive software processes 208, and not other types of software processes 208.

The multi-field efficiency metric 302 additionally includes a fifth field 312 indicating a memory-intensive power efficiency value 324 of the execution node 206. In accordance with the described techniques, the system software 214 marks software processes 208 as memory-intensive software processes 208 based on the software processes 208 being estimated to invoke at least a threshold amount of memory usage at the execution node 206. Given this, the execution node 206 generates the memory-intensive power efficiency value 324 based on the computational performance (e.g., clock frequency and/or throughput) and dynamic power consumption exhibited by the execution node 206 when executing the memory-intensive software processes 208. Like the efficiency metric 220, the memory-intensive power efficiency value 324 is directly related to dynamic power efficiency of the execution node 206. However, unlike the efficiency metric 220, the communication-intensive power efficiency value 322 is computed based on the observed power consumption and computational performance characteristics of the execution node 206 while executing memory-intensive software processes 208, and not other types of software processes 208.

Furthermore, the multi-field efficiency metric 302 includes a sixth field 314 indicating a local temperature 326 of the execution node 206, and a seventh field 316 including an aging indicator 328. The local temperature is a current operating temperature of the execution node 206. The aging indicator 328 is a value indicative of an age of the execution node 206 and a historical amount of usage of the execution node 206. By way of example, the execution node 206 increases the aging indicator periodically (e.g., every month), thereby capturing the age of the execution node 206. In addition, the execution node 206 adjusts the aging indicator based on total resource usage invoked at the execution node 206 over a lifetime of the execution node 206. Alternatively, an age of the execution node 206 and a historical usage amount of the execution node 206 are present in separate fields of the multi-field efficiency metric 302.

In variations, the multi-field efficiency metric 302 includes any number of fields indicating any combination of the aforementioned categories of computational performance and power consumption characteristics. Additionally or alternatively, the multi-field efficiency metric 302 includes additional fields indicating different categories of computational performance and power consumption characteristics. Further, although the example 300 is described with reference to a multi-field efficiency metric 302 of a particular execution node 206, it is to be appreciated that the registers 218 include multi-field efficiency metrics 302 associated with each of the plurality of execution nodes 206.

In one or more implementations, the scheduler 150 distributes the software processes 208 to the execution nodes 206 based on a totality of the information conveyed by the multi-field efficiency metrics 302 of the plurality of execution nodes 206. By way of example, the scheduler 150 considers the overall efficiency metrics 220, the idle power efficiency values 318, the compute-intensive power efficiency values 320, the communication-intensive power efficiency values 322, the memory-intensive power efficiency values 324, the local temperatures 326, and the aging indicators 328 of respective execution nodes 206 when making work distribution decisions. Additionally or alternatively, the scheduler 150 distributes the software processes 208 based on the specific categories of computational performance and power consumption characteristics conveyed by specific fields of the multi-field efficiency metric 302.

By way of example, the scheduler 150 reads the multi-field efficiency metrics 302 of the plurality of execution nodes 206 from the registers 218. Furthermore, the scheduler 150 reserves one or more execution nodes 206 for future scale out operations of the software processes 208 based on the idle power efficiency values 318, specifically. For example, the scheduler 150 reserves, as the reserve nodes, the execution nodes 206 having idle power efficiency values 318 that exceed a threshold. This is because the idle power efficient execution nodes 206 consume less power in idle and near-idle utilization states, and the reserve nodes frequently operate in these utilization states.

In addition, the system software 214 classifies a software process 208 as a compute-intensive software process 208 based on the software process 208 being estimated to invoke at least a threshold amount of processing resources at a respective execution node 206, as previously mentioned. Furthermore, the scheduler 150 distributes the compute-intensive software process 208 to an execution node 206 having a compute-intensive power efficiency value 320 that exceeds a threshold.

Similarly, the system software 214 classifies a software process 208 as a communication-intensive software process 208 based on the software process 208 being estimated to invoke at least a threshold percentage of communication/network bandwidth at a respective execution node 206, as previously mentioned. Furthermore, the scheduler 150 distributes the compute-intensive software process 208 to an execution node 206 having a communication-intensive power efficiency value 322 that exceeds a threshold.

Moreover, the system software 214 classifies a software process 208 as a memory-intensive software process 208 based on the software process 208 being estimated to invoke at least a threshold percentage of memory resources at a respective execution node 206, as previously mentioned. Furthermore, the system software 214 distributes the memory-intensive software process 208 to an execution node 206 having a memory-intensive power efficiency value 324 that exceeds a threshold.

Although examples are discussed herein in which the efficiency metrics 220 and/or the multi-field efficiency metrics 302 are generated per compute node (e.g., execution node 206) of the system 200, these examples are not to be construed as limiting. In at least one additional or alternative example in which the system 200 employs virtualization and virtual machines 212, for instance, the efficiency metrics 220 and/or the multi-field efficiency metrics 302 are generated per virtual machine 212 in accordance with the described techniques. In this example, a virtual machine 212 generates the efficiency metric 220 and/or the multi-field efficiency metric 302 of the virtual machine 212 by observing the underlying characteristics of the execution node 206 running the virtual machine 212, e.g., clock frequency, computational performance, dynamic power consumption, static power consumption, local temperature, and aging indicator.

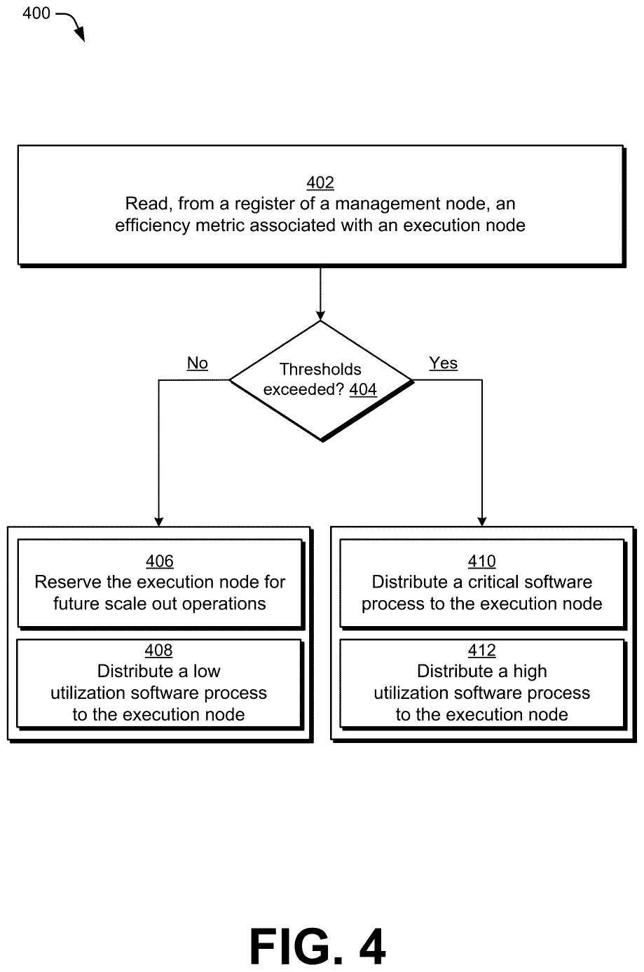

FIG. 4 depicts a procedure 400 in an example implementation of work distribution in a data center based on compute node efficiency as implemented by a management node. In the procedure 400, an efficiency metric associated with an execution node is read from a register of a management node (block 402). By way of example, the scheduler 150 of the management node 204 reads an efficiency metric 220 associated with an execution node 206 from the registers 218.

It is determined whether the efficiency metric exceeds various defined thresholds (block 404). For example, the scheduler 150 determines whether the efficiency metric 220 associated with the execution node 206 exceeds the reservation threshold, the efficiency threshold, and/or the critical execution threshold.

If the efficiency metric falls below the reservation threshold (e.g., “no” at block 404), the execution node is reserved for future scale out operations (block 406). By way of example, the scheduler 150 reserves the execution node 206 for future scale out operations of the software processes 208 based on the efficiency metric 220 of the execution node 206 falling below the reservation threshold.

If the efficiency metric falls below the efficiency threshold (i.e., “no” at block 404), a low utilization software process is distributed to the execution node (block 408). For instance, a software process 208 is classified as a low utilization software process 208 based on an estimated resource utilization ratio estimated to be invoked by the software process 208 at the execution node 206 falling below a node utilization threshold. Further, the scheduler 150 allocates the low utilization software process 208 to the execution node 206 based on the efficiency metric 220 of the execution node 206 falling below the efficiency threshold.

If the efficiency metric exceeds a critical execution threshold (i.e., “yes” at block 404), a critical software process is distributed to the execution node (block 410). For example, software process 208 is classified as a critical software process based on SLAs of the software process. Further, the scheduler 150 allocates the critical software process 208 to the execution node 206 based on the efficiency metric 220 of the execution node 206 exceeding the critical execution threshold.

If the efficiency metric exceeds the efficiency threshold (e.g., “yes” at block 404), a high utilization software process is distributed to the execution node (block 412). For instance, a software process 208 is classified as a high utilization software process 208 based on an estimated resource utilization ratio estimated to be invoked by the software process 208 at the execution node 206 exceeding a node utilization threshold. Further, the scheduler 150 allocates the high utilization software process 208 to the execution node 206 based on the efficiency metric 220 of the execution node 206 exceeding the efficiency threshold.

As further discussed above with reference to FIGS. 2 and 3, the scheduler 150 distributes the software processes 208 in a variety of other manners than those depicted and described above with respect to the procedure 400 of FIG. 4. For example, the scheduler 150 issues migration instructions to move software processes from less efficient execution nodes 206 (e.g., having relatively lower efficiency metrics 220) to more efficient execution nodes 206, e.g., having relatively higher efficiency metrics. Additionally, when distributing a multi-node software process 208, the scheduler 150 distributes the multi-node software process 208 to multiple execution nodes 206 in a manner that reduces performance variance across the multiple execution nodes 206. To do so, the scheduler 150 distributes the multi-node software process 208 to execution nodes 206 exhibiting efficiency metrics 220 within a defined range of one another. Additionally or alternatively, the scheduler 150 adjusts power consumption of the multiple execution nodes 206 to normalize computational performance (e.g., throughput or clock frequency) across the multiple execution nodes 206. Additionally or alternatively, the scheduler 150 adjusts amounts of work within workloads supplied to the multiple execution nodes 206 to normalize the processing time to execute the workloads by the multiple execution nodes 206.

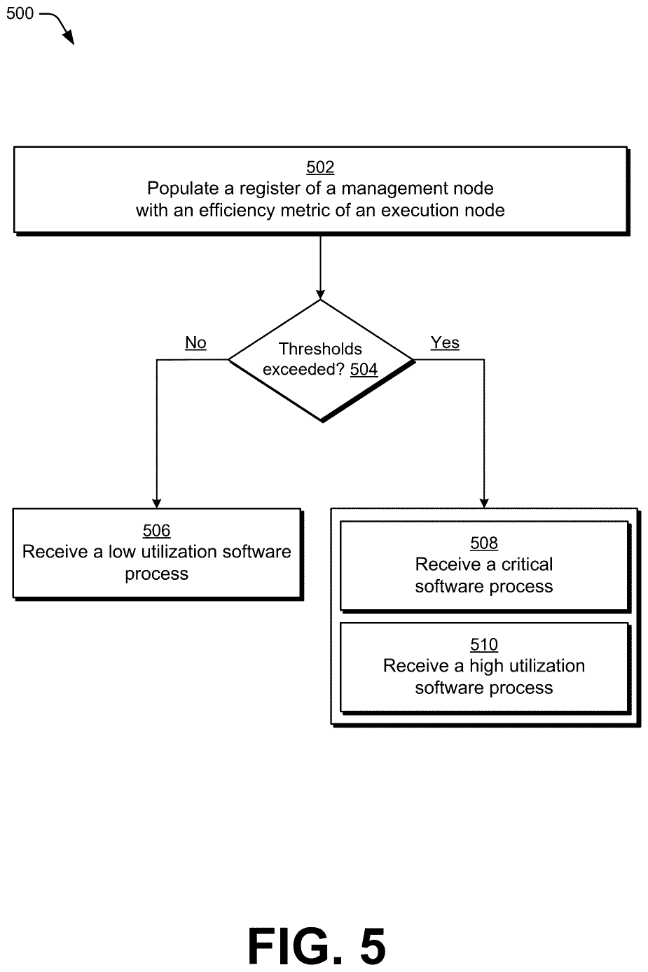

FIG. 5 depicts a procedure 500 in an example implementation of work distribution in a data center based on compute node efficiency as implemented by an execution node. In the procedure 500, a register of a management node is populated with an efficiency metric of an execution node (block 502). By way of example, an execution node 206 generates an efficiency metric 220 by observing computational performance (e.g., throughput and/or clock frequency), dynamic power consumption, and static power consumption exhibited by the execution node 206. As part of this, the execution node 206 increases the efficiency metric 220 responsive to observing increased computational performance, decreased dynamic power consumption, and increased static power consumption. In other words, the efficiency metric has a direct relationship with dynamic power efficiency (e.g., the ratio of computational performance to dynamic power consumption) and static power consumption. The execution node 206 periodically writes the efficiency metric 220 to a register 218 of the management node 204 associated with and/or assigned to the execution node 206.

If the efficiency metric falls below an efficiency threshold (i.e., “no” at block 504), the execution node receives a low utilization software process (block 506). By way of example, the efficiency metric 220 of the execution node 206 is below the efficiency threshold, and the execution node 206 receives a low utilization software process 208 estimated to invoke a resource utilization ratio at the execution node 206 that is below a node utilization threshold. Further, the execution node 206 executes the low utilization software process

If the efficiency metric exceeds a critical execution threshold (i.e., “yes” at block 504), the execution node receives a critical software process (block 508). For example, the efficiency metric 220 of the execution node 206 is above a critical execution threshold, and the execution node 206 receives a software process 208 classified as critical based on SLAs of the software process 208. Further, the execution node 206 executes the critical software process.

If the efficiency metric exceeds the efficiency threshold, (i.e., “yes” at block 504, a high utilization software process is received (block 510). For instance, the efficiency metric 220 of the execution node 206 is above the efficiency threshold, and the execution node 206 receives a high utilization software process 208 estimated to invoke a resource utilization ratio at the execution node 206 that exceeds the node utilization threshold. Further, the execution node 206 executes the high utilization software process.

What is claimed is:

1. A system comprising:
a plurality of compute nodes including a management node and a plurality of execution nodes, the management node having a processor configured to:
read, from one or more registers of the management node, efficiency metrics associated with respective execution nodes of the plurality of execution nodes; and
distribute software processes among the plurality of execution nodes for execution based on the efficiency metrics.

2. The system of claim 1, wherein the efficiency metrics are directly related to dynamic power efficiency and static power consumption of the respective execution nodes.

3. The system of claim 1, wherein the efficiency metrics are a function of one or more of ages of the respective execution nodes, local temperatures of the respective execution nodes, and historical usage amounts of the respective execution nodes.

4. The system of claim 1, wherein an efficiency metric of a respective execution node includes multiple fields indicating different categories of computational performance and power consumption characteristics, wherein the multiple fields include two or more of:
a first field indicating idle power efficiency of the respective execution node;
two or more second fields indicating the computational performance and power consumption characteristics of the respective execution node while executing different types of the software processes;
one or more third fields indicating an age and a historical amount of usage of the respective execution node; and
a fourth field indicating a local temperature of the respective execution node.

5. The system of claim 1, wherein the processor is configured to reserve an execution node for future scale out operations of the software processes based on an efficiency metric of the execution node falling below a threshold.

6. The system of claim 1, wherein the processor is configured to distribute a low utilization software process to a low efficiency execution node having an efficiency metric that is below a first threshold, the low utilization software process estimated to invoke a resource utilization ratio that is below a second threshold at the low efficiency execution node.

7. The system of claim 1, wherein the processor is configured to distribute a high utilization software process to a high efficiency execution node having an efficiency metric that exceeds a first threshold, the high utilization software process estimated to invoke a resource utilization ratio that exceeds a second threshold at the high efficiency execution node.

8. The system of claim 1, wherein the processor is configured to issue one or more migration instructions causing migration of a software process from a first execution node to a second execution node responsive to resource utilization at the plurality of execution nodes having decreased, a first efficiency metric of the first execution node being less than a second efficiency metric of the second execution node.

9. The system of claim 1, wherein the processor is configured to:
classify a software process as a critical software process; and
distribute the critical software process to a high efficiency execution node having an efficiency metric that exceeds a threshold.

10. The system of claim 1, wherein the processor is configured to distribute a multi-node software process to multiple execution nodes having the efficiency metrics within a defined range of one another.

11. The system of claim 1, wherein the processor is configured to distribute a multi-node software process to multiple execution nodes by adjusting amounts of work within workloads of the multi-node software process allocated to the multiple execution nodes based on the efficiency metrics to normalize an amount of time to process the workloads by the multiple execution nodes.

12. The system of claim 1, wherein the processor is configured to distribute a multi-node software process to multiple execution nodes by adjusting power consumption of the multiple execution nodes based on the efficiency metrics to normalize computational performance across the multiple execution nodes.

13. A system comprising:
a plurality of compute nodes including a management node and a plurality of execution nodes, an execution node of the plurality of compute nodes configured to:
populate a register of the management node with an efficiency metric of the execution node; and
receive a software process from the management node for execution based on the efficiency metric.

14. The system of claim 13, wherein the efficiency metric is directly related to dynamic power efficiency and static power consumption of the execution node.

15. The system of claim 13, wherein the software process is a low utilization software process estimated to invoke a resource utilization ratio below a first threshold at the execution node, and the low utilization software process is received based on the efficiency metric falling below a second threshold.

16. The system of claim 13, wherein the software process is a high utilization software process estimated to invoke a resource utilization ratio that exceeds a first threshold at the execution node, and the high utilization software process is received based on the efficiency metric exceeding a second threshold.

17. A method comprising:
reading, by a management node, efficiency metrics of a plurality of execution nodes from one or more registers of the management node, the efficiency metrics having multiple fields indicating different categories of computational performance and power consumption characteristics of the plurality of execution nodes; and
distributing by the management node, software processes to the plurality of execution nodes for execution based on the efficiency metrics.

18. The method of claim 17, wherein the multiple fields include a field indicating idle power efficiencies of the plurality of execution nodes, and distributing the software processes includes reserving an execution node for future scale out operations of the software processes based, in part, on an idle power efficiency of the execution node exceeding a threshold.

19. The method of claim 17, wherein the multiple fields include a field indicating compute-intensive power efficiencies of the plurality of execution nodes while executing compute-intensive software processes, and distributing the software processes includes distributing a compute-intensive software process to an execution node based, in part, on a compute-intensive power efficiency of the execution node exceeding a threshold.

20. The method of claim 17, wherein the multiple fields include a field indicating communication-intensive power efficiencies of the plurality of execution nodes while executing communication-intensive software processes, and distributing the software processes includes distributing a communication-intensive software process to an execution node based, in part, on a communication-intensive power efficiency of the execution node exceeding a threshold.
